(19) United States
(12) Patent Application Publication
(10) Pub. No.: US 2025/0390942 A1
(43) Pub. Date: Dec. 25, 2025

(54) SYSTEMS AND METHODS FOR USE IN ORCHESTRATING DATA CONNECTIONS

(71) Applicant: MASTERCARD INTERNATIONAL INCORPORATED, PURCHASE, NY (US)

(72) Inventors: Ben Soccorsy, Larkspur, CA (US); Ryan Raymond Beaudry, Redding, CT (US); Jacqueline Mary Till Young, Philadelphia, PA (US)

(21) Appl. No.: 19/239,842

(22) Filed: Jun. 16, 2025

Related U.S. Application Data
(60) Provisional application No. 63/662,996, filed on Jun. 21, 2024.

(51) Int. Cl. G06Q 40/02

(52) U.S. Cl. CPC G06Q 40/02

(57) ABSTRACT

Systems and methods are provided for use in orchestrating data connections. One example computer-implemented method includes receiving, by an orchestration host computing device, an access request for a user and, in response to the request, identifying, through an open service, multiple accounts issued to the user by different account hosts. The computer-implemented method also includes identifying, by the computing device, consent terms for each of the account hosts, aggregating the identified consent terms for the account hosts, and presenting, at a communication device associated with the user, the aggregate consent terms to the user. The computer-implemented method then includes, based on acceptance from the user of the aggregate consent terms, submitting, by the computing device, a data connection request to each of the account hosts.

### CROSS-REFERENCE TO RELATED APPLICATION

This application claims the benefit of, and priority to, U.S. Patent Application No. 63/662,996, filed on Jun. 21, 2024. The entire disclosure of the above application is incorporated herein by reference.

### FIELD

The present disclosure generally relates to systems and methods for orchestrating data connections, and in particular, to systems and methods for use in orchestrating data connection to account(s), through common consent experiences.

### BACKGROUND

This section provides background information related to the present disclosure which is not necessarily prior art.

It is known for entities to provide for open services, whereby access to data and/or services is more readily available to other entities. One example of an open service is open banking and/or open finance, whereby user-permissioned financial and non-financial data is shared between banks and third-party service providers, and even the users (consumers) whom the data describes. As such, consumers (e.g., end users, etc.) to whom bank accounts are issued (e.g., the individuals or entities to whom/which the bank accounts belong, etc.), as part of open banking, are enabled to manage their financial data across different platforms.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in orchestrating data connections;

FIG. 2 is a block diagram of an example computing device that may be used in the system of FIG. 1; and

FIG. 3 includes a flow diagram of an example method, which may be implemented in connection with the system of FIG. 1, for use in orchestrating data connections.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Open services, such as, for example, open banking services, etc., provide for wider access to data (e.g., name, address, phone number, email address, account balance, transaction history, services utilized, etc.) stored by different account hosts (e.g., account issuers, etc.). Open banking, in particular, provides for the user-consented sharing of data from account hosts, services, platforms, etc. The access/sharing is based, in some examples, on the use of login credentials specific to the account host, whereby the user, to connect multiple accounts, is required, for each account host or for each account, to request the data connection, identify the account host, authenticate or login, confirm the account (and/or details relating to the account), and review and consent to access conditions (e.g., terms and conditions, etc.), etc. In connection with an overall data view associated with multiple different accounts (e.g., overall financial view, etc.), the user is required to repeat the above for each account and/or account host, in order to grant complete access, through data connections, to the platform. The process is onerous, time consuming, and further presents vulnerability or exposure of certain secure data.

Uniquely, the systems and methods herein provide for orchestration of multiple data connections, through a common sequence of enrollment.

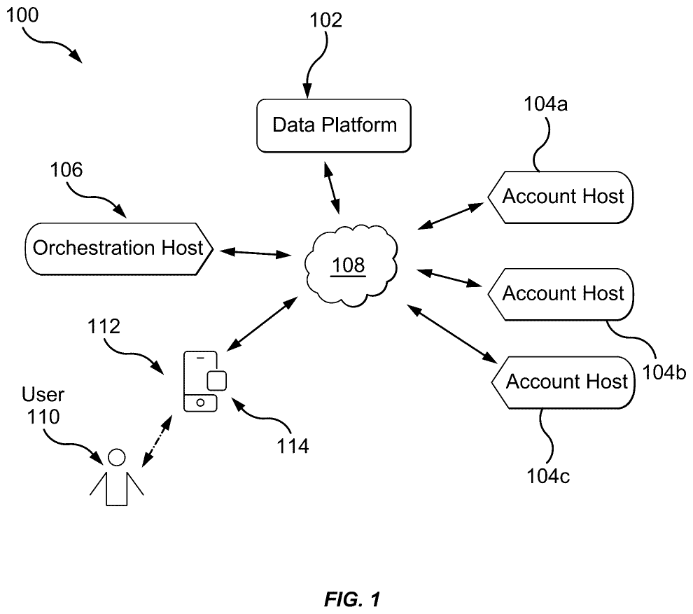

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships, types of users/hosts, open service types, privacy regulations and/or requirements, etc.

The system 100 generally includes a data platform 102, multiple account hosts 104a-c, and an orchestration host 106, each of which is coupled to (and is in communication with) network 108. The network 108 may include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The data platform 102 is configured to provide data services based on accessed account data for users (e.g., user 110, etc.). That is, the data platform 102 is configured to consume data for users, through data connections, and then to compile, analyze, summarize, etc., the data in forms and formats useful to the users. One example of the data platform 102 is a financial data platform (e.g., including personal accounting software, etc.), which is configured to access financial data for the user 110 and to present spending summaries and patterns, total costs, common costs, income summaries, payment schedules, tax summaries and reporting, budgets, etc. The user 110 may then view the same and make decisions related to future expenditures, financial planning, etc. One example of a financial data platform is the INTUIT QUICK BOOKS product. Other example data platforms may include, without limitation, accounting software, digital wallets, etc.

In this example embodiment, the account hosts 104a-c include financial institutions, which are configured to offer one or more financial services to users, including the user 110. That is, each account host 104 is generally a financial institution or a financial services provider, such as, for example, a bank, investment host, insurance provider, a small business Saas (Software as a Service) provider, etc. The account hosts 104a-c are configured to issue accounts to users, which may include financial accounts (e.g., checking accounts, savings accounts, credit accounts, debit accounts, prepaid accounts, brokerage accounts, etc.) as well as other accounts like life/auto/home insurance accounts, brokerage accounts, mortgage accounts, as well as accounts relating to non-financial services, etc. whereby the accounts are associated with and/or hold, pay, or receive funds on behalf of the users to which the accounts are issued. Again, while the description herein is provided in terms of the account hosts 104a-c being a bank or financial institution, other account hosts may be included in other example embodiments.

As should be apparent, in order to process data as described herein, it is necessary to provide data connection between the account hosts 104a-c and the data platform 102.

In connection therewith, the system 100 includes the orchestration host 106, which is configured to enable data connection between the data platform 102 and one or more of the account hosts 104a-c.

In particular, with reference to the user 110, the user 110 is associated with a communication device 112, which includes an application 114 provided by, or enabled by, the data platform 102. The application 114 includes a software development kit (SDK) (not shown), which is provided, hosted, or offered by the orchestration host 106, as an option to enable data connections to multiple accounts at one time, along with relevant data scopes to streamline user (or consumer) permissioned access to those accounts. In order to enable the data connections to multiple accounts at the account hosts 104a-c, the user 110 accesses the application 114, at the communication device 112, and requests that his/her data be made accessible to the data platform 102 through multiple data connections. In doing so, the user 110 presents details, as part of the request, for one of his/her accounts to be linked, such as a credit account, etc. The details include, in this example, the account number (e.g., primary account number PAN), expiration date, card verification code (CVC), name, mailing address, mobile phone number, email address, etc. The details may be manually entered by the user 110 to the communication device 112, captured from a photo or an NFC tap of a physical card, etc.

The communication device 112 is configured, by the application 114 (and SDK therein), to capture the details of the request and to provide the request the orchestration host 108. It should be appreciated that the user 110 may repeat the above for multiple different accounts at one or more of the account hosts 104a-c for which data access is to be provided.

It should be appreciated that the user 110 may be subject to authentication to the application 114, or the communication device 112, or the data platform 102, prior to, or in connection with, submitting the request. For example, biometric authentication local to or remote from the communication device 112 may be relied upon prior to permitting the user 110 to submit a request. Or, the data platform 102 may be configured to transmit a one time passcode (OTP) to the phone number or email address included in the request, whereby the user 110 is required to return the OTP, through the application 114, for example, or otherwise, whereupon the OTP is verified prior to the request being submitted to the orchestration host 106. Other types of authentication, such as, for example, through digital credentials, digital identities, etc., may be employed in connection with the request for data connections, and coordinated by the communication device 112, the data platform 102, etc.

Regardless, in turn, the orchestration host 106 is configured to identify accounts issued to the user 110, based on the detail of the request, for example, through one or more open banking services to which the account hosts 104a-c are subscribed. The account(s) are identified by, for example, the orchestration host 106 being configured to cooperate with one or more of the account hosts 104a-c to match the name, phone number, email address, mailing address, etc., included in the request to the same data associated with accounts issued by the account hosts 104a-c. The orchestration host 106, in this way, is configured to identify bank accounts (e.g., checking accounts, savings accounts, etc.), payment accounts (e.g., credit accounts, prepaid accounts, debit account, etc.), or other types of accounts, etc., at the account hosts 104a-c. In one embodiment, the orchestration host 106 may be configured to identify accounts from only one account host 104a-c at a time, or alternatively, in other embodiments, from more than one of the account hosts 104a-c at a time, etc.

It should be appreciated that the user 110 may be previously enrolled for open banking services, or not.

In one example, the accounts are matched using the mobile phone number, or email address, through a MASTERCARD CONNECT PLUS service, whereby accounts active on the MASTERCARD open banking network are identified and presented to user 110. In another example, where the communication device 112 is an APPLE IPHONE device, a passkey associated with a wallet therein (included in the request from the communication device 112) may be used to identify account(s). In another example, accounts may be identified through matching based on the user's authentication of an external account, such as, for example, account information associated to an account of which the user 110 has permissioned access. In yet another example, the accounts may be identified through matching associated with a user profile established using a digital credential or tokenized reference ID that represents multiple accounts permissioned by the suer 110 through one or more common authentication protocols.

In general, the identified accounts include all of the accounts issued to the user 110 (or includes accounts consistent with the request from the user 110 (e.g., all of one type of account, or all accounts from a specific one of the account hosts 104a-c, etc.), etc.), by ones of the account hosts 104a-c, which subscribe to the open banking service. The identified accounts therefore include, as applicable, the account identified in the request and one or more other accounts.

The orchestration host 106 is configured to present the identified accounts to the user 110, at the communication device 112. In turn, the user 110 is permitted to view the identified accounts (e.g., by identifier, nickname, description, account host 104, etc.), and potentially, provide additional details or input for additional account hosts 104a-c not included in the identified accounts, whereupon the orchestration host 106 is configured to identify further accounts, if any, issued by the account hosts 104a-c based on the additional details or identification of the same from the user 110.

The communication device 112 is configured, by the application 114 (and the SDK), to solicit selection of one or more the identified account(s) for which data connections are to be made (and, in some examples, for which consent is provided). In turn, the user 110 selects one or more of the identified accounts for which data is to be shared with application 114. The communication device 112 is configured, by the application 114 (and the SDK), to pass the selections of the accounts to the orchestration host 106.

In response, the orchestration host 106 is configured to identify consent terms for the selection account (or account hosts 104a-c) and to aggregate the consent terms for each of the selected accounts. In particular, each of the account hosts 104a-c may impose different terms and conditions for consent on access to data associated with accounts issued thereby. The orchestration host 106 is configured to select ones of the consent terms for those account hosts 104a-c, which issued the selected accounts. The orchestration host 106 is configured to then aggregate the consent terms into a single set of consent terms. The aggregation may include, for example, eliminating redundant terms, creating generic terms (to offset, collapse, or combine multiple specific terms), etc. For example, where one consent term from the account host 104b relates to data security (broadly, a subject), and a consent term from the account host 104c also relates to data security, one of the terms may be selected and the other deleted based on the terms being related to the same subject, i.e., data security (i.e., where satisfying the selected consent term also satisfies the deleted consent term). This may be based, for example, on selecting a more rigorous data security requiring specific encryption schemes, and deleting the term that is less rigorous on data security, thereby permitting selection of suitable encryption schemes for both (and of which the specific selected encryption scheme is permitted by both data security options). It should be appreciated that the aggregation of the consent terms is generally associated with the reduction or elimination of redundancies on the consent terms, etc. The orchestration host 106 is configured to provide the aggregate consent terms to the communication device 112.

In addition to aggregating consent terms from disparate accounts, the orchestration host 106 may be configured to further include additional terms related to access, such as, for example, permission to maintain access, permission to reauthorize the data connection (at one or more intervals), permission for future consent terms, permission to define revocation of consent and/or authorization conditions (e.g., in aggregate for all accessible accounts, or individually among the account by user selection, etc.), and/or permission to improve account management post initial authorization. It should be appreciated that other terms may be associated with the data connection(s), which may be presented by the orchestration host 106 for approval, acceptance, etc., by the user 110.

The communication device 112 is configured, by the application 114 (and the SDK), to display or otherwise present the aggregate consent terms to the user 110, who, in turn, accepts or declines the aggregate consent terms. When declined, the communication device 112 is configured, by the application 114 (and the SDK), to end the enabling of the data connections.

Conversely, when accepted by the user 110, through an input from the user 110 to the communication device 112 (e.g., checking an “Accept” box, or selecting an “Approve” button, etc.), the communication device 112 is configured, by the application 114 (and the SDK), to provide the approval back to the orchestration host 106. The orchestration host 106 is configured to compile evidence of the acceptance by the user 110, via the communication device 112, and the specific aggregate consent terms viewed and accepted by the user 110.

In this example embodiment, based thereon, the orchestration host 106 is configured to enable the data connections, through the open services (e.g., open banking services, etc.) between the data platform 102 and the account hosts 104a-c, as selected, on behalf of the user 110, as described more below.

In doing so, the orchestration host 106 is configured to facilitate submission of a request for a secure open service connection, established by the user 110 directly with the account hosts 104a-c, where the request includes a request to issue an access token for the new data connection (per account host 104a-c). The request includes the name of the user 110, along with mailing address, phone number, email; address, and other suitable data, etc., and also an indication of authentication of the user 110 (i.e., an assurance of authentication) (e.g., in lieu of login credentials specific to the user 110 for the specific account host 104, etc.) and an assurance of acceptance of the terms and conditions of the specific account host 104. This is repeated, sequentially or in parallel for each of the account hosts 104a-c for which a data connection is consented. In this manner, the request for the data connection may be consistent, or even the same, among the different account hosts 104a-c.

In response, each of the account hosts 104a-c is configured to confirm the request and, when the respective one of the account hosts 104a-c is satisfied with the request (e.g., data, assurances, etc. included therein, etc.), to generate the access token, to sign the access token, and to provide the access token and certain identifying data back to the orchestration host 106. The orchestration host 106 is configured, then, to receive the access tokens from the account hosts 104a-c and to pass the access tokens along to the data platform 102, for use in establishing data connection with the account hosts 104a-c. The orchestration host 106 may be configured to provide the access tokens to the data platform 102, directly, or the orchestration host 106 may be configured to generate a special access token, based on (or derived from) the access token from the account host 104a, for example, and then provide the special access token to the data platform 102. In connection with either, the orchestration host 106 is configured to enable the user 110 to authorize, reauthorize or revoke the access to the particular account host 104a, for example, though the access token associated wit the particular account host 104a.

The data platform 102, in turn, is configured to establish the data connection with each of the account hosts 104a-c (as selected by the user 110), based on the access tokens or special access token(s). The account host 104a, for example, is configured to receive the corresponding access token, decode, and check/verify the access token as being genuine, valid, etc., whereby access to the data specific to the account of the user 110 is permitted whereby the account host 104a is configured to either provide the data or permit the data to be accessed therefrom, etc. The account hosts 104b-c are configured to proceed in a similar manner. The data platform 102 is then configured to access data through the established data connections. In this way, the data platform 102 is configured to access any desired data, including, for example, historical data related to transactions, balances, interest, etc., or other financial or non-financial data, etc., as appropriate for the account issued to the user 110 by the one of the account hosts 104a-c, consistent with applicable consent, terms, rules, and regulations, etc. The data platform 102 is configured to then assess, compile, aggregate, summarize, etc., the data from the account hosts 104a-c and to present the data in a requested, desired, standard form and/or format to the user 110, via the application 114 at the communication device 112.

Alternatively, in some example embodiments, the orchestration host 106 may be configured to participate in the data access, for example, via the access token(s). For instance, instead of providing the access token(s) to the data platform 102, the orchestration host 106 may use the access token(s) to establish the data connection(s) with the account hosts 104a-c. In doing so, the orchestration host 106 may decode and check/verify the access token(s) as being genuine, valid, etc., whereby access to the data specific to the account of the user 110 is permitted for the orchestration host 106. The orchestration host 106 is then configured to access data through the established data connection(s). In this way, the orchestration host 106 is configured to access any desired data, including, for example, historical data related to transactions, balances, interest, etc., or other financial or non-financial data, etc., as appropriate for the account issued to the user 110 by the one of the account hosts 104a-c, consistent with applicable consent, terms, rules, and regulations, etc. The orchestration host 106 is configured to then assess, compile, aggregate, summarize, etc., the data from the account hosts 104a-c and to present the data in a requested, desired, standard form and/or format to the user 110, via the application 114 at the communication device 112. Or, in some examples, the orchestration host 106 may communicate the accessed data to the data platform 102, whereby the data platform 102 is configured to assess, compile, aggregate, summarize, etc., the data from the account hosts 104a-c and to present the data in a requested, desired, standard form and/or format to the user 110, via the application 114 at the communication device 112.

The communication device 112 is configured, in turn, by the application 114, to present the data to the user 110 in one or more suitable manners.

It should be appreciated that the data connections are generally ongoing, whereby the data platform 102 (or the orchestration host 106) is configured to intermittently pull data, via the access token(s), for the account(s) specific to the user 110 from the account hosts 104a-c (e.g., every fifteen minutes, hour, six hours, twelve hours, daily, weekly, monthly, etc.), or the account hosts 104a-c are configured to push, based on the access tokens, data associated with the account(s) of the user 110 to the data platform 102 (or the orchestration host 106) (e.g., real time transaction reporting, etc.). In this way, the data platform 102 is configured to access future data (in addition to the historical data), via the access tokens from the account hosts 104a-c.

It should also be appreciated that the communication device 112 is configured, by the application 114 (and the SDK), to solicit input from the user 110 for continuing the data connections from time to time. For example, any changes in the terms and condition may be presented to the user 110, via the communication device 112, similar to the description above, and also, the user 110 may be permitted to manually enable or disable the access tokens, where the data connections may be enabled or disabled, per account and/or account host 104a-c, as desired by the user 110.

In connection with the above, the access tokens may further be used, for example, to support provisioning of specific services, including, for example, real-time payments by the account hosts 104a-c, in addition to the data access described above, with less friction (or at any other party to a secure connection), which supports provisioning of financial and non-financial services to users.

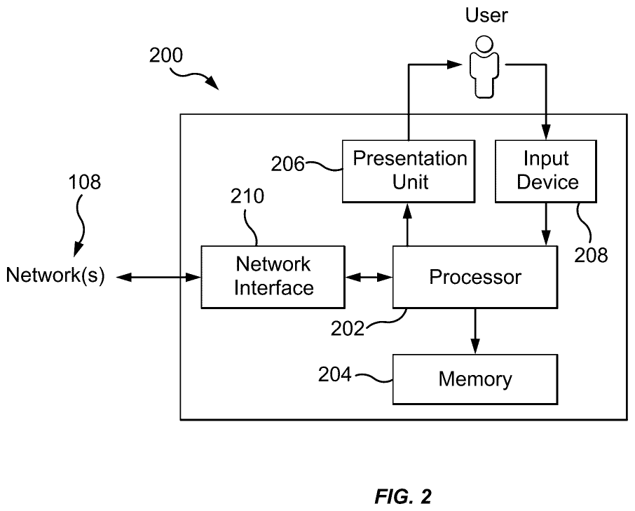

FIG. 2 illustrates an example computing device 200 that may be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to operate as described herein. In the example embodiment of FIG. 1, each of data platform 102, the account hosts 104a-c, the orchestration host 106 and the communication device 112 are understood to be included in, or as being generally implemented in, at least one computing device generally consistent with computing device 200, coupled to (and in communication with) the one or more networks. However, with that said, the system 100 should not be considered to be limited to the computing device 200, as described below, as different computing devices and/or arrangements of computing devices may be used.

Referring to FIG. 2, the example computing device 200 includes a processor 202 and a memory 204 coupled to (and in communication with) the processor 202. The processor 202 (as well as the processor 128) may include one or more processing units (e.g., in a multi-core configuration, etc.). For example, the processor 202 (as well as the processor 128) may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, floppy disks, tapes, hard disks, and/or any other type of volatile or nonvolatile physical or tangible computer-readable media. The memory 204 may be configured to store, without limitation, data associated with users, access tokens, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein, whereby such performance improves operation of the computing device (as described herein) and transforms the computing device 200 into a special-purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, such as listings of identified accounts, prompts for user input, etc., audibly or visually, for example, to a user of the computing device 200, such as the user 112 in the system 100, etc. The presentation unit 206 may include, without limitation a liquid crystal display (LCD), a light-emitting diode (LED) or LED display, an organic LED (OLED) display, an “electronic ink” display, speakers, etc. In some embodiments, presentation unit 206 may include multiple devices.

In addition, the computing device 200 includes an input device 208 that receives inputs from the user of the computing device 200 (i.e., user inputs) such as, for example, selections of options to link accounts, selections of identified accounts to link, etc., as further described herein. The input device 208 may include a single input device or multiple input devices. The input device 208 is coupled to (and is in communication with) the processor 202 and may include, for example, a keyboard, a pointing device, a mouse, a sensor, a touch sensitive panel (e.g., a touch pad or a touch screen, etc.), another computing device, and/or an audio input device, etc. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., Wi-Fi adapter, a near field communication (NFC) adapter, a Bluetooth adapter, etc.), a mobile network adapter, or other device capable of communicating to one or more different networks, including the network 108. Further, in some example embodiments, the computing device 200 may include the processor 202 and one or more network interfaces incorporated into or with the processor 202.

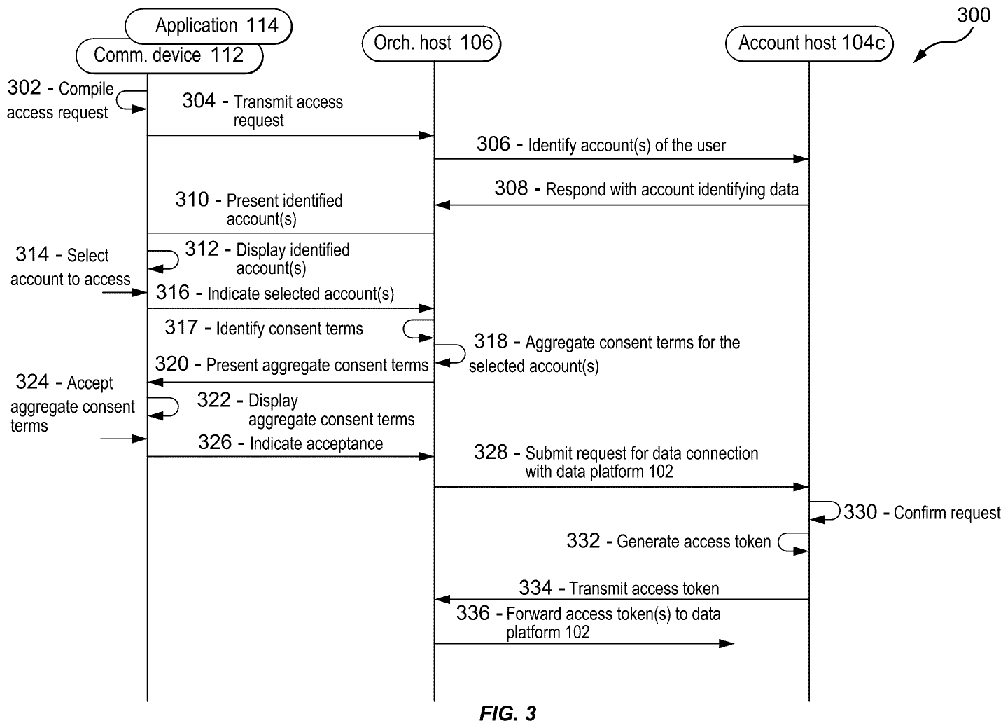

FIG. 3 illustrates an example method 300 for use in securing open service connections. The example method 300 is described as implemented in the orchestration host 106 and other aspects of the system 100. And, reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, it should be appreciated that the user 110 is associated with multiple different accounts, which may include different types of accounts (e.g., credit payment accounts, saving accounts, insurance accounts, etc.). The accounts are issued to the user 110 by the account hosts 104a-c. In connection therewith, the user 110 desires to access a data product from the data platform 102, which is enabled by access to data associated with the accounts of the user 110.

As such, the user 110 downloads and installs the application 114 from the data platform 102 (directly or indirectly (e.g., through an application store, etc.)) to the communication device 112.

In order to enable the data connections to the multiple accounts issued by the account hosts 104a-c, the user 110 access the application 114 and selects an option to enable the data platform 102 to access the accounts. In this example embodiment, the user 110 provides identifying details, which include a name, mailing address, email address, mobile phone number, and credentials associated with one of the accounts issued by the account hosts 104a-c (e.g., account number (e.g., primary account number PAN), expiration date, card verification code (CVC), etc.). At 302, the communication device 112, via the application 114 and the SDK, compiles the above data into a request for access.

At 304, the communication device 112, via the application 114 and the SDK, transmits the access request to the orchestration host 106.

It should be appreciated that the user 110 is authenticated in connection with any request for access, via one or more authentication schemes approved, hosted or sponsored by the orchestration host 106.

In response to the access request, at 306, the orchestration host 106 identifies accounts issued to the user 110, based on the detail in the access request, for example, through one or more open banking services to which the account hosts 104a-c are subscribed. In connection therewith, the orchestration host 106 transmits an identification request to the account host 104c, which includes, for example, a phone number, email address, etc. The account host 104c, in turn, performs a lookup for accounts associated with the data in the identification request. When one or more accounts is found, the account host 104c responds with account identifying data, such as, for example, an account type, a portion of the account number, etc., at 308.

As shown in FIG. 3, the identifying of the account(s) is directed, by the orchestration host 106, only to the account host 104c, the orchestration host 106 repeats the step with the account hosts 104a-b. In this way, in general, the identified accounts include all of the accounts issued to the user 110, by ones of the account host 104a-c, which subscribe to the open banking service. The identified accounts therefore include, as applicable, the account(s) identified in the request and other accounts.

In turn, at 310, the orchestration host 106 presents the identified account(s) to the communication device 112, and at 312, the communication device 112 displays the identified account(s) to the user 110. The account(s) may be identified by the account host name, partial account number, account type, etc. In turn, the user 110 reviews the account(s) and, at 314, selects one or more of the accounts for which to provide access to the data platform 102. The communication device 112 indicates, at 316, the selected account(s) to the orchestration host 106. In response, the orchestration host 106 identifies, at 317, the consent terms specific to each of the multiple account hosts 104a-c (e.g., specific to the hosts, accounts, etc.), and aggregates, at 318, the consent terms for each of the selected account(s). In particular, each of the account hosts 104a-c may impose different terms and conditions for consent on access to data associated with accounts issued thereby. The orchestration host 106 is configured to select ones of the consent terms for those account hosts 104a-c, which issued the selected one or more of the identified accounts. The orchestration host 106 is configured to then aggregate the consent terms into a single set of consent terms. The orchestration host 106 provides, at 320, the aggregate consent terms to the communication device 112.

At 322, the communication device 112 displays the aggregate consent terms to the user 110. The aggregation may include, without limitation, eliminating duplicate terms, compiling general term(s) to collapse multiple related or common terms into fewer terms, standardizing the terms/language of the terms, etc., while remaining consistent with the original terms from the different account hosts 104a-c. For example, where a consent term for the account host 104a includes a 30-day interval of data, and the consent term for the account host 104b includes a 45-day interval of data, the aggregate term may indicate the 45-day interval of data (as it subsumes or includes the 30-day interval of data). In other examples, the consent terms may be considered where the consent terms include the same subject, or where the consent terms include selecting more restrictive terms (while deleting the corresponding less restrictive terms). The aggregation by definition herein reduces the number of terms, which is in contrast to merely combining all the terms from the different account hosts 104 (i.e., adding the terms together without combining, deleting, or reducing the terms). That is, the terms are combined, where permitted, while preserving the overall terms of consent.

In turn, the user 110 reviews the aggregate consent terms and, at 324, accepts, in this example, the aggregate consent terms. The communication device 112 indicates, at 326, the acceptance to the orchestration host 106.

Based thereon, the orchestration host 106 enables the data connections between the data platform 102 and the account hosts 104a-c, as selected, on behalf of the user 110, as described more below.

In doing so, for the account host 104c, for example, the orchestration host 106 submits, at 328, via the open banking service, a request for a secure open service connection between the data platform 102 and the account host 104c, where the request includes a request to issue an access token for the new data connection. The request includes the name of the user 110, along with mailing address, phone number, email address, etc., and also an indication of authentication of the user 110 (i.e., an assurance of authentication) (e.g., in lieu of login credentials specific to the user 110 for the specific account host 104, etc.) and an assurance of acceptance of the terms and conditions of the specific account host 104a-c. In this manner, the request for the data connection may be consistent, or even the same, among the different account hosts 104a-c.

In response, the account host 104c, for example, confirms, at 330, the request and, when satisfied with the request (e.g., data, assurances, etc. included therein; confirmation with the user 110 (e.g., notification for authorization, reauthorization, or revocation, etc., from which the user 110 may or may not respond, to protect user access and control, etc.); etc.), generates, at 332, the access token. The account host 104c may further sign the access token. Next, at 334, the account host 104c transmits the access token and certain identifying data back to the orchestration host 106. At 336, after receiving an access token from the account host 104c, and also from each of the account hosts 104a-b, in a similar manner, the orchestration host 106 forwards the access tokens to the data platform 102, which permits the data platform 102 to access historical, present and future data for the selected account(s) directly through the account hosts 104a-c, using the respective access tokens.

In view of the above, the systems and methods herein permit a new way to enroll for open banking use cases, which leverage card details to identify accounts and to create data connections for a data platform, i.e., through a single access request directed, from the orchestration host, to multiple different account hosts. This permits users to avoid the tedious account linking process for each account host to be linked to the data platform, which are generally time consuming, onerous, etc., while still abiding by and enforcing consent terms consistent with the terms specific to each of the account hosts.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited herein, including in the claims, for example: (a) receiving an access request for a user; (b) identifying, through an open service, multiple accounts issued to said user, each of the multiple accounts issued by a different one of multiple account hosts; (c) identifying, for each of the multiple account hosts, multiple consent terms; (d) aggregating the identified consent terms for the multiple account hosts, thereby reducing a number of the terms; (e) presenting, at a communication device associated with the user, the aggregate consent terms to the user; and/or (f) based on acceptance from the user of the aggregate consent terms, submitting a data connection request to each of the multiple account hosts.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in orchestrating data connections, the method comprising:
receiving, by an orchestration host computing device, an access request for a user;
identifying, by the computing device, through an open service, multiple accounts issued to said user, each of the multiple accounts issued by a different one of multiple account hosts;
identifying, by the computing device, for each of the multiple account hosts, multiple consent terms;
aggregating, by the computing device, the identified consent terms for the multiple account hosts, thereby reducing a number of the identified consent terms;
presenting, by the computing device, at a communication device associated with the user, the aggregate consent terms to the user; and
based on acceptance from the user of the aggregate consent terms, submitting, by the computing device, a data connection request to each of the multiple account hosts.

2. The computer-implemented method of claim 1, wherein the open service includes an open banking service.

3. The computer-implemented method of claim 1, further comprising presenting the identified accounts to the user, at the communication device associated with the user; and
receiving a selection of a plurality of the multiple accounts;
wherein identifying the consent terms includes identifying the consent terms for only the selected plurality of the multiple accounts.

4. The computer-implemented method of claim 1, wherein receiving the access request includes receiving the access request from the communication device associated with the user.

5. The computer-implemented method of claim 1, wherein aggregating the identified consent terms includes combining at least one of the consent terms for one of the multiple account hosts with at least one of the consent terms for a different one of the multiple account hosts, thereby reducing the number of the identified consent terms.

6. The computer-implemented method of claim 1, further comprising:
receiving, in response to the data connection request, an access token from each of the multiple account hosts; and
forwarding the access tokens, from the multiple account hosts, to a data platform, whereby, in response to the access tokens, the data platform is permitted to establish data connection with each of the multiple account hosts to access data specific to the identified accounts.

7. The computer-implemented method of claim 6, wherein the access request and the data connection requests include an email address and/or a mobile phone number of the user.

8. A non-transitory computer-readable storage medium comprising executable instructions for use in orchestrating data connections, which when executed by at least one processor, cause the at least one processor to:
receive, from a communication device of a user, an access request for the user;
identify, through an open service, multiple accounts issued to said user, each of the multiple accounts issued by a different one of multiple account hosts;
identify multiple consent terms required for the multiple account hosts;
aggregate the multiple consent terms for the multiple account hosts;
present, at the communication device associated with the user, the aggregate consent terms to the user;
receive an acceptance of the aggregate terms from the user, via the communication device; and
based on acceptance from the user of the aggregate consent terms, submit a data connection request to each of the multiple account hosts, the data connection request include the acceptance by the user.

9. The non-transitory computer-readable storage medium of claim 8, wherein the open service includes an open banking service.

10. The non-transitory computer-readable storage medium of claim 8, wherein the executable instructions, when executed by the at least one processor, further cause the at least one processor to:
present the identified accounts to the user, at the communication device associated with the user; and
receive, from the communication device, a selection by the user of a plurality of the multiple accounts; and
wherein the executable instructions, when executed by the at least one processor to identify the consent terms, cause the at least one processor to identify the consent terms for only the selected plurality of the multiple accounts.

11. The non-transitory computer-readable storage medium of claim 8, wherein the executable instructions, when executed by at least one processor to receive the access request, cause the at least one processor to receive the access request from the communication device associated with the user.

12. The non-transitory computer-readable storage medium of claim 8, wherein the executable instructions, when executed by at least one processor to aggregate the consent terms, cause the at least one processor to combine ones of the consent terms for one of the multiple account hosts with ones of the consent terms for a different one of the multiple account hosts, thereby reducing a number of the consent terms.

13. The non-transitory computer-readable storage medium of claim 8, wherein the executable instructions, when executed by at least one processor to aggregate the consent terms, cause the at least one processor to select one of the consent terms for one of the multiple account hosts and to delete one of the consent terms for a different one of the multiple account hosts, based on subjects of the selected one of the consent terms and the deleted one of the consent terms being the same.

14. The non-transitory computer-readable storage medium of claim 8, wherein the executable instructions, when executed by the at least one processor, further cause the at least one processor to:
receive, in response to the data connection request, an access token from each of the multiple account hosts; and
forward the access tokens, from the multiple account hosts, to a data platform, whereby, in response to the access tokens, the data platform is permitted to establish data connection with each of the multiple account hosts to access data specific to the identified accounts.

15. The non-transitory computer-readable storage medium of claim 8, wherein the access request and the data connection requests include an email address and/or a mobile phone number of the user.
